(19) United States
(12) Patent Application Publication
(10) Pub. No.: US 2007/0178190 A1
(43) Pub. Date: Aug. 2, 2007

(54) Grape treatment method for wine production and winemaking container

(76) Inventor: Yves Vatelot, Saint Loubes (FR)

Correspondence Address: YOUNG & THOMPSON, 745 SOUTH 23RD STREET, 2ND FLOOR, ARLINGTON, VA, 22202, US

(21) Appl. No.: 10/570,881

(22) PCT Filed: Oct. 24, 2003
(86) PCT No.: PCT/FR03/50107

§ 371 Date: Dec. 4, 2006

(30) Foreign Application Priority Data
Oct. 24, 2002 (FR) 0213305

(51) Int. Cl. C12G 1/00

(52) U.S. Cl. 426/15

(57) ABSTRACT

A grape treatment process for barrel winemaking, the grapes having if desired been de-stemmed and crushed. A barrel (30) equipped for the practice of this grape treatment process is also disclosed. The barrel has a base (32) including an opening (56) with a closure plate (58), an outlet (40) and fixed stirring elements.

The present invention relates to a process for grape treatment for the production of wine.

The invention also covers the container necessary for this process, more particularly a barrel for winemaking, associated with the process of winemaking.

Winemaking in a barrel is more and more practiced by producers because it leads to wines having taste qualities that are altogether specific and different from those known until now.

Barrel winemaking consists in ensuring the step of fermentation directly in a barrel and not in wooden vats, in metallic tanks or concrete tanks.

The first problem is introducing the grapes into the container, generally a wooden barrel, more particularly of oak. Another constraint is that of recovering the must on the one hand and the marc on the other hand at the end of fermentation in a barrel. The present invention provides a suitable solution.

This solution must also take into account the economical parameters and it is necessary to be able to reuse the barrels having served for fermentation notwithstanding the equipment necessary for the introduction and fermentation in the barrel.

It is also known that during barrel fermentation, if it is desired that the tannins and the polyphenols in particular, express themselves in a better fashion, it is necessary also to provide good impregnation of the cake of marc which forms by simple decantation. This cake is always present no matter what the container, and no matter what the dimensions of these containers, but in the present case, with a small container, the obstacle is also that of accessibility to the interior, the bunghole being of small diameter.

In a large vat, there exists a method called pigeage which consists in ensuring a must/marc mixture by alternate vertical movement of a rod manipulated by an operator. Such an action is repeated several times per day.

Pigeage is difficult to practice because the only access to the barrel is a bunghole of several centimeters in diameter. Not only is the opening very small, but the operation of repeating in each barrel becomes costly and troublesome because it is necessary to draw the bung, agitate as much as possible the contents despite the difficulty and re-close the barrel bung and then transfer this pigeage tool and then repeat the operation on another barrel. In each case, the mechanical disturbance created is insufficient to obtain good results.

Another method for containers having a large volume uses a pump which withdraws a fraction of the liquid to distribute it over the marc by sprinkling. While passing through the cake, the liquid fraction impregnates this marc and expresses all the substances. Such means and modalities are inapplicable to volumes such as those of barrels.

At the end of harvest, the grapes must be subjected preferably to a pre-fermentation treatment, particularly of temperature control to avoid untimely beginning of fermentation, bruising by removal of the first juice and/or an addition of natural product such as sulfur or enzymes.

According to the type of wine, the winemaker in charge may adjust the marc/must ratio to be introduced into the barrels according to the properties of the grapes of the same vineyard. Thus, these properties can be modified by climatic variations, the date and conditions of harvest or in the treatments carried out. To obtain a quality wine, the winemaker increases the ratio of marc to must to produce particularly an increase in the tannic character.

The present invention permits solving the problems thus posed and providing a process giving very satisfactory winemaking results, with technical means that can be carried out industrially and at an acceptable cost for this type of barrel winemaking.

The process for grape processing according to the present invention and the associated container permitting the practice of this process, will now be described in detail according to a particular embodiment, which is not limiting, with respect to the accompanying drawings, in which the different figures show:

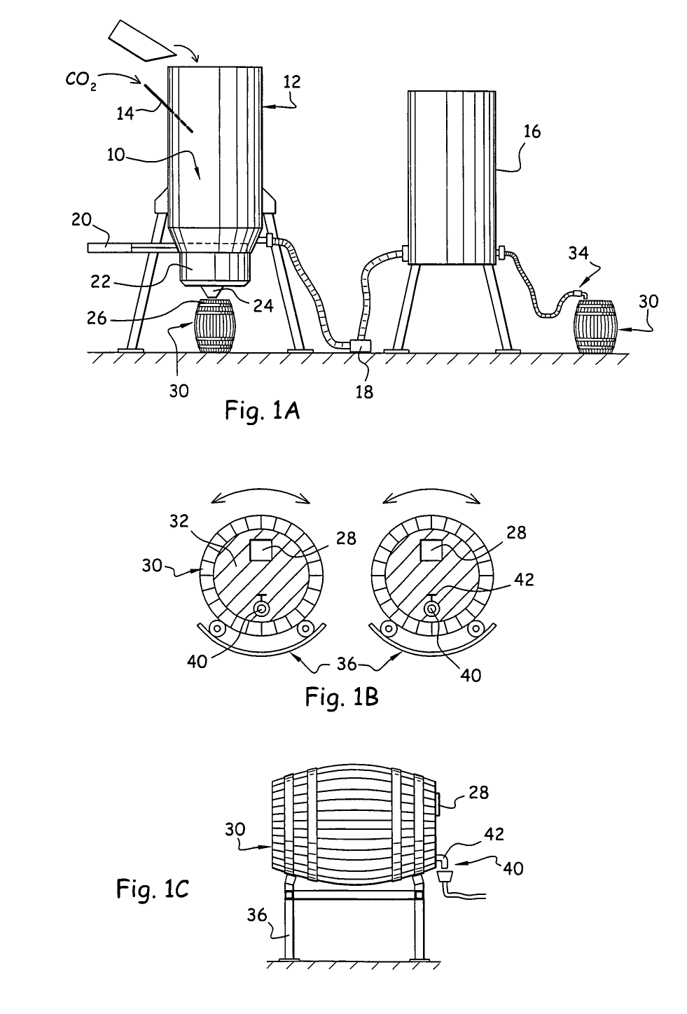

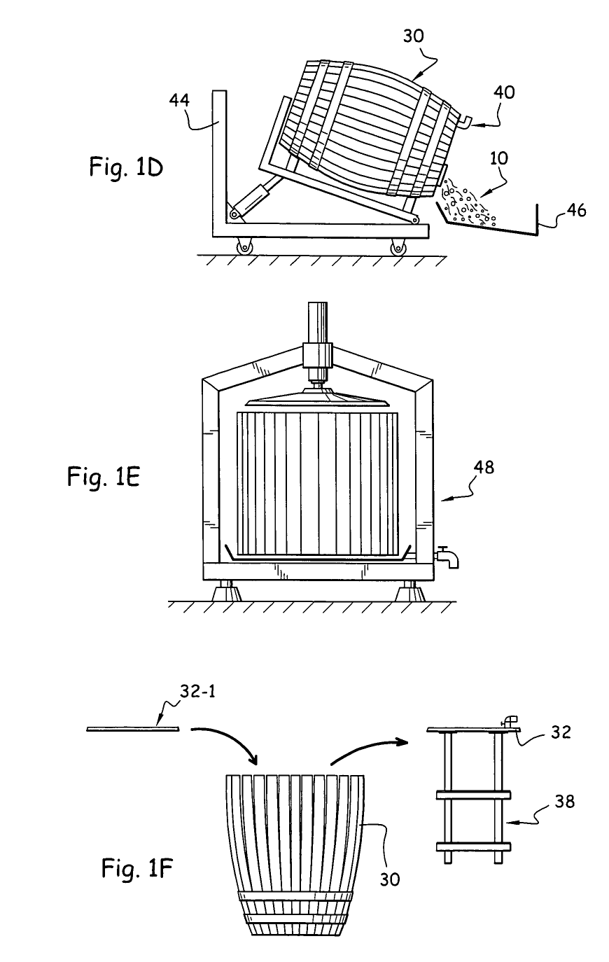

FIG. 1A to 1G, a schematic view of the different steps of treating the grapes,

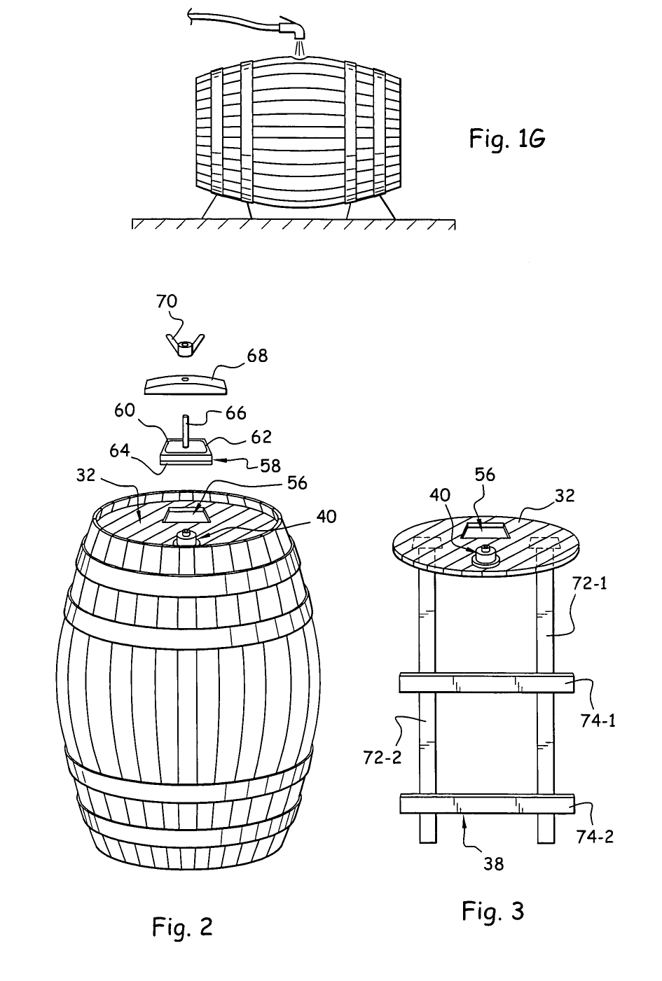

FIG. 2, a perspective view of an open barrel for practicing the process,

FIG. 3, a perspective view, separated and detailed, of the base of the barrel,

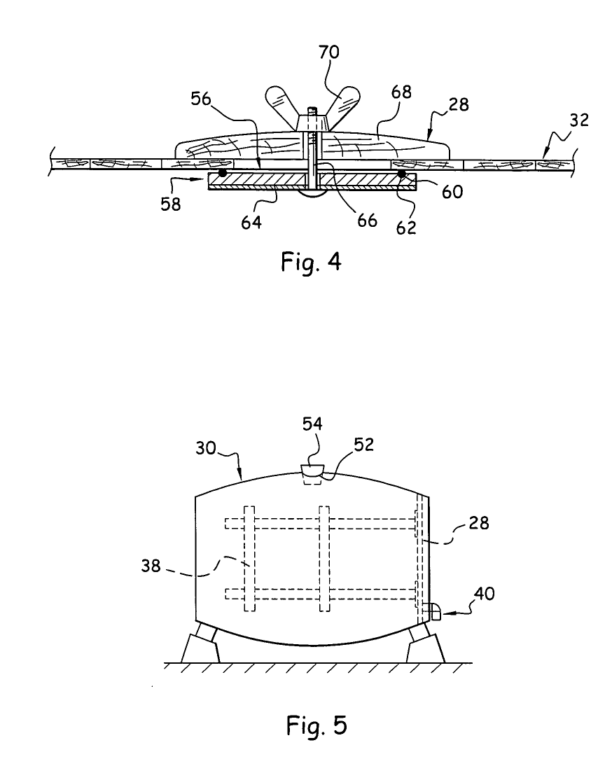

FIG. 4, a cross-sectional view of an embodiment of the closure door, and

FIG. 5, a view of a barrel provided according to the invention on a support, in the course of fermentation.

The process according to the invention comprises the steps shown in FIG. 1A to 1G.

In step 1A, the grapes 10, after harvesting, de-stemming and possible crushing, are fed to a pre-fermentation vat 12. In this vat, the grapes accumulate and under the effect of gravity, the must is concentrated at the base of the vat whilst the marc has a natural tendency to form an upper layer.

When the vat is full, C0₂ is injected if needed through a pipe 14 which permits regulating the temperature of the grapes to avoid the onset of fermentation, in addition to rendering it inert which limits oxidation. Similarly, as needed, or in a single addition, sulfur and yeast are added for the following fermentation. The sulfur may moreover have been introduced previously, directly into the crusher.

At this stage, there can be carried out a first bruising and a fraction of juice can be withdrawn so as to increase the marc/juice proportion. This juice will not be further reused for the production of the wine according to the process of the present invention.

At the end of filling, the juice accumulated in this pre-fermentation vat is withdrawn so as to leave in the vat essentially only the marc. This juice is transferred to a wine storage vat 16 by a pump 18.

Then barrels are filled by measuring out the quantity of marc from the pre-fermentation vat, through a valve 20, for example by a cutoff blade which delivers a selected quantity of marc into a buffer hopper 22. All or nothing closure means comprising also a funnel 26, permit funneling the marc through a closure 28 provided in a barrel 30 held upright, hence into the base 32 of said barrel.

This same barrel 30 is filled with juice from the wine-holding vat 16, with a funnel valve 34, in the course of this same step of measuring/filling.

These barrels thus contain the grapes prepared and dosed with a marc/juice ratio, ready for fermentation.

The barrels 30 are arranged on supports 36 which can be parallel rails or individual supports more sophisticated with cradles and rollers as those available in commerce under the mark “OXO”.

The object is to oscillate the barrels to ensure good impregnation of the marc by the juice. However, it is known that, when the marc floats, it is hardly moved and the barrel turns without the contents rocking much. The friction on the walls is insufficient to ensure stirring.

The present invention proposes placing fixed stirring means 38, described in greater detail hereafter. These stirring means are secured to the cover carrying the closure 28.

Thus, when the barrel is rotated, the fixed stirring means 38 permit stirring the two phases present in the barrel. This is step 1B.

There is thus produced a slow and homogeneous but overall extraction of the tannins and polyphenols as well as good exchange with the wood of which the barrel is made. These stirring means have a very great importance and play an essential role in the quality of the final product.

This same base also comprises an outlet 40 with a valve 42.

In step 1C, the situation is after fermentation, which is to say after the transformation of the sugar into alcohol, about 15 days to give an order of magnitude with stirring three or four times per day.

The liquid phase, of the wine before pressing, is withdrawn through the outlet 40 and transferred to a wine-holding vat (not shown), as is done in known manner when the fermentation takes place in a vat of large size.

The marc itself remains in the barrel and it is necessary to withdraw it and to press it to extract the remaining line.

In step 1D is shown a support 44 which permits inclining the barrel after having opened the closure 28.

This marc is collected in a transfer vat 46 which permits filling a press 48, shown schematically in step E.

This press permits expressing the wine which is also conducted to wine wine-holding vats, like the pre-pressed wine previously withdrawn.

Several solutions are possible at this stage of the winemaking process.

Either the pre-pressed wines and the pressed wines are processed together and hence assembled, or else the two wines are treated independently, each in its own barrel.

In the present operation, the two wines are treated separately.

The barrel 30 is then prepared to receive the wines. The base 32 carrying the closure 28, the outlet 40 and the fixed stirring means 38 is removed by preliminarily taking off the metallic bands 50 and by spacing apart the barrel staves. This is step 1F.

This outfitted base is replaced by a simple new base 32-1. The bands are then replaced and the barrel is simple and of known type with its only access the bunghole 52, closed by a bung 54.

The barrel 30 having served for fermentation is thus reused to receive each of the wines and to hold them during malolactic fermentation in the course of which the red wines lose a portion of their acidity.

The latter can take place over several days which follow the filling of the barrel or at the latest during generally two months, and it is interesting to carry out this step in the same barrel because the final organoleptic properties are remarkable.

The wine is thus replaced in its container, namely its fermentation barrier, for its maturing or storage and to keep the great wines.

The number of barrels used is reduced because the volume of marc is decreased and there is also a small loss of liquid in the course of the different steps.

It will be seen that the grapes thus treated permit blending in the best way the tannins of the wood with those of the wine.

In FIG. 2, it is seen that the face 32 is cut out with an opening 56, square in the embodiment in question. The closure 28 comprises a closure plate 58 adapted to pass through the opening diagonally.

This plate 58 comprises a peripheral joint 60, preferably torric, disposed in the groove 62, machined in this same plate.

Stiffening means 64 can be added to ensure an effective mating.

A connecting rod 66 projects beyond a securement crosspiece 68, which contacts the external surface of the base whilst a nut 70, in this case a wing nut, permits ensuring the forming of the joint carried by the plate 58 against the base 32, on its internal surface.

The fixed stirring means 38 are shown in detail in FIG. 3, in the form of a preferred embodiment but certainly not limiting.

The means comprise two vertical parallel bars 72-1, 72-2 of stainless steel to meet agrofood standards, secured to the base 32 and two transverse bars 74-1 and 74-2, connected to the two vertical bars, for example by welding.

These stirring means are of great interest to ensure gentle but complete impregnation of the marc, over all its volume and thereby to extract all the components in a slow but thorough manner.

In FIGS. 4 and 5, there is seen supplemental explanatory representations permitting better appreciating the arrangement according to the present invention. Identical elements have the same reference numerals.

There can also be envisaged all manner of closure of the opening and particularly a circular opening with a bung of the radially expansible type.

Such a process requires means available industrially at relatively low cost, compared to the gain in quality of the wine obtained by this process.

1-8. (canceled)

9. Grape treatment process for barrel winemaking, said grapes having if desired been de-stemmed and crushed, characterized in that it comprises the following steps:
gathering all the grapes in a pre-fermentation vat,
filling a barrel with marc and juice through an opening provided in one of its bases, called an equipped base,
letting fermentation take place until complete transformation of the sugars into alcohol while regularly oscillating the barrel provided with fixed stirring means to ensure gentle extraction of the tannins and polyphenols,
withdrawing the wine before crushing by flow and placing it in wine storage,
withdrawing the marc by the same opening provided in one of its bases and pressing this marc to collect the pressed wine and placing it in a wine storage, and
placing these wines in barrels.

10. Grape treatment process according to claim 9, characterized in that the equipped base is replaced by a simple base and the barrels are refilled with these wines before and/or after pressing through the bunghole of said barrels.

11. Grape treatment process according to claim 9, characterized in that draining is carried out from the pre-fermentation vat.

12. Grape treatment process according to claim 9, characterized in that it comprises the following supplemental steps:
withdrawing juice from the pre-fermentation vat and placing it in a wine storage,
holding the marc in this pre-fermentation vat, and
introducing into the barrel the marc and the juice in a given ratio.

13. Grape treatment process according to claim 9, characterized in that the grapes are subjected in the pre-fermentation vat to temperature and/or the addition of yeast.

14. Barrel (30) for practicing the grape treatment process according to claim 9, characterized in that it comprises an equipped base (32) comprising an opening (56) with a closure plate (58), an outlet (40) and fixed stirring means (38).

15. Barrel (30) according to claim 14, characterized in that the opening (56) is square and in that the closure plate (58) passes through this opening diagonally, comprises a peripheral joint (60) disclosed in a groove (62) in this same plate, this plate being also provided with a connecting rod (66), a securement crosspiece (68), a nut (70) arranged so as to ensure pressing the joint (60) against the internal surface of the base (32).

16. Barrel (30) according to claim 14, characterized in that the fixed stirring means (38) comprises two vertical parallel bars (72-1, 72-2) secured to the base (32) and two transverse bars (74-1, 74-2) connected to these two vertical bars.
